(19) United States
(12) Patent Application Publication
(10) Pub. No.: US 2001/0024109 A1
(43) Pub. Date: Sep. 27, 2001

(54) Power supply system

(76) Inventors: Mark Sobkow, Miltord, MI (US); Steven J. Brodzik, Plymouth, MI (US); Greg Giles, Westland, MI (US)

Correspondence Address: Barbara M. Burns, 1756 Plymouth Road # 276, Ann Arbor, MI, 48105, US

(21) Appl. No.: 09/789,094

(22) Filed: Feb. 20, 2001

Related U.S. Application Data
(60) Provisional application No. 60/183,831, filed on Feb. 21, 2000.

(51) Int. Cl. H04M 11/00; G05F 1/613; H04M 3/00

(52) U.S. Cl. 323/225; 379/102.04; 379/307

(57) ABSTRACT

An improved power supply system/device and/or method that supports a network with at least two power supplies running continuously as compared to a system that switches standby power supplies in and out as needed. Current is drawn from both of the power supplies or from only one power supply should one of the power supplies fail. The improved power supply system provides trunk line power to a segment of a network by concurrently operating multiple power supply devices with the power supply devices being configured in a load sharing configuration and can employ a current limiting circuit.

This application is based on Provisional Patent Application Serial No. 60/183,831 filed Feb. 21, 2000.

### BACKGROUND OF THE INVENTION

The field of the invention pertains to electrical power supply systems, and the networks of devices that they power. More particularly, the invention pertains to an improved power supply to provide power to a network, or a segment of a network of communication devices, such as LAN transceivers. The invention also can provide trunk line power to a network. Attempts have been made to assure non-interruption of power supply such as by switching an extra standby power supply into and out of the system as needed when a regular power supply fails. This was not very satisfactory and a better solution to this problem was needed.

### SUMMARY OF THE INVENTION

The invention is an improved power supply system/device and/or method of use that supports a network with at least two power supplies, each continuously supplying power to user devices, as compared to a system that switches standby power supplies in and out as needed. The invention implements functionality on the network on which it is powering devices (i.e., if it were powering a DeviceNet network, a DeviceNet interface is provided. However, other interface devices can be employed such as an Ethernet, MODbus, etc.). These communications make available the status of the power supply and network, including current, voltage output, and any problems with individual power supplies, or detectable network problems. Since a number of power supplies are provided, that may be capable of providing more current than a given network's media may be able to handle, adjustable current limiting can be incorporated into the invention.

Under normal operating conditions, the target network of this power supply system draws an equal amount of current from all power supplies provided by the invention. Power supplies incorporated into the system can be sized such that upon the failure of a known number of the power supplies (depending upon the size of the system) the remaining power supplies are capable of providing adequate current to the system they are powering.

The improved power supply system according to the invention provides trunk line power to a network or segment of a network by concurrently operating multiple power supply devices. The invention incorporates load sharing and current limiting circuits. Thus, the invention provides power with continuously operable power supplies.

The load sharing circuitry ensures that each provided power supply is equally loaded, typically at a level far below each power supply's maximum operating amperage. The load sharing circuit is implemented so that any individual power supply is not heavily loaded, which may help the life cycle of each power supply. The current limiting circuit is implemented to protect network media by supplying a limited amount of electrical current as determined by the network specifications. This limit can be changeable to a number of preset levels through either hardware or software configuration.

Control and communications sub-systems of the power supply system monitor the electrical voltage and current of each power supply as well as the total voltage and current being delivered to the network. These systems read these values through analog inputs and convert them into values that can be available over network communications. This information can provide a network technician the ability to know how close the actual electric voltage and current signals are in relation to electrical limits expressed within the network specifications. For example, prior to making any changes to the network, a network technician can check the status of the power supply, current being supplied to the network, and confirm that any change or addition would not cause the network to move out of electrical specifications. The system can also make available discrete input and output. These input and output points can provide a means to record or control many different signals such as the number of active power supplies, or run on external indicators that can be used to display status information. One of the digital outputs can energize a relay that could interrupt the outgoing power. This option provides a convenient method to reset the power to an entire, or segment of a specific network.

The circuit board can employ a commercially available microprocessor. This microprocessor along with the supporting electronics components provides the electrical signal conditioning, monitoring, digital signal monitoring and control and network communications.

These and other advantages and features of novelty which characterize the invention are pointed out as follows. For a more complete understanding of the present invention, reference is made to the following detailed description when read with in conjunction with the accompanying drawings wherein like reference characters refer to like elements throughout the several views, in which:

### BRIEF DESCRIPTION OF THE DRAWINGS

FIG. 1 illustrates a power supply system with a switch in and switch out standby backup power feature; and

FIG. 2 illustrates a continuously running power supply backup system.

### DESCRIPTION OF THE PREFERRED EMBODIMENTS

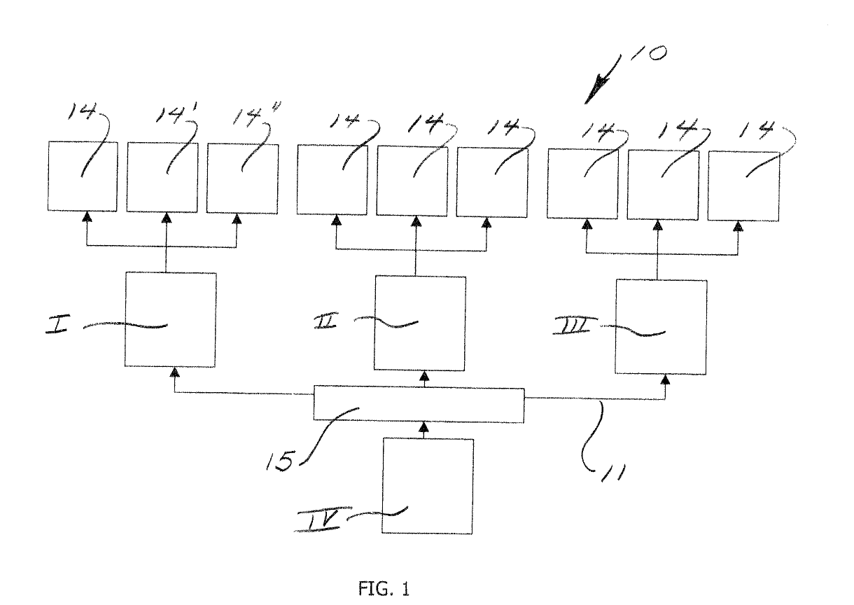

Now turning to the drawings, an example of a power supply system 10 with a switch in and switch out standby backup power feature is shown as a network circuit 11 with power supplies I, II, and III in FIG. 1. Network devices 14, 14′, etc. are powered by the power supplies I, II, and III. A monitoring and switching device 15 is interposed between the power supplies I, II and III and the standby back up power supply IV. A standby back up power supply IV is provided to be used should any of the regular power supplies I, II, or III became unavailable. The standby backup power supply IV is switched into the network circuit 11 to provide power only to the segment that was supplied by the primary power supply I or II or III that became unavailable.

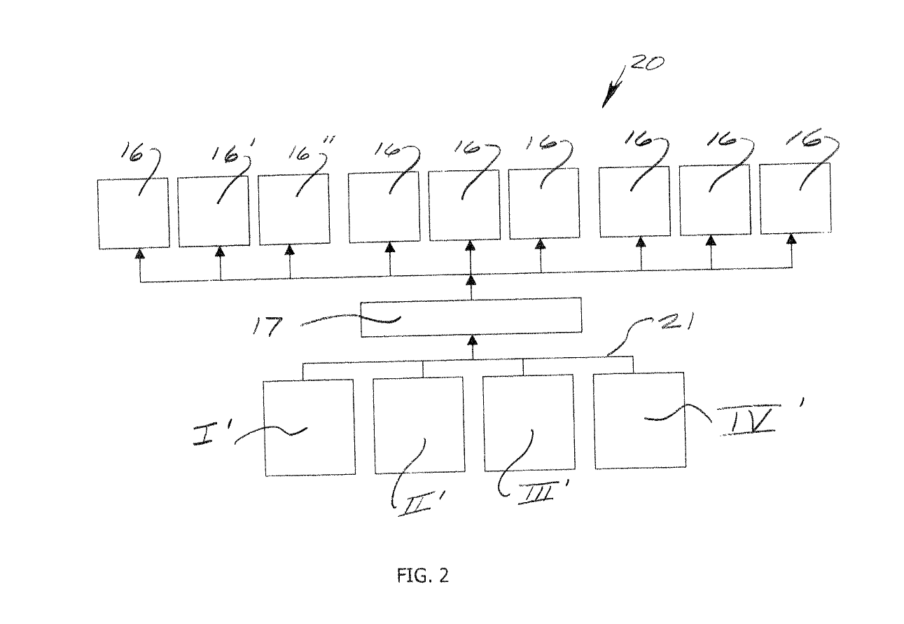

Now referring to FIG. 2, a continuously running power supply backup system 20 is shown as a network circuit 21 having concurrently running power supplies I′, II′, III′, and IV′. Network circuit 21 uses all power supplies I′, II′, III′, and IV′ that are continuously operating in the circuit 20. Devices 16, 16′, etc. are powered by the power supplies I′, II′, III′, and IV′. A monitoring and control device 17 is interposed between the devices 16, 16′, etc. and the power supplies I′, II′, III′ and IV′. Should one of the power supplies I′, II, III′, or IV′ be unavailable, the remaining power supplies of I′, II′, III′, and IV′ cover the power requirements of the network circuit 21.

It is to be understood that the system/device and/or method herein described could be employed for uses and purposes beyond those described. The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. An improved power supply system to provide trunk line power to one of a segment of a network and a network, the improvement comprising:
a multiplicity of power supply devices, the multiplicity of power supply devices being concurrently operable.

2. An improved power supply system to provide trunk line power to a segment of a communications network, the power supply having power supply devices, the improvement comprising:
the power supply devices being configured in a load sharing configuration.

3. The improved power supply system to provide trunk line power to a segment of a communications network according to claim 2 further comprising:
current limiting circuit to limit current to the network.

4. The improved power supply system to provide trunk line power to a segment of a communications network according to claim 2 further comprising:
a load sharing circuitry to load each of power supply devices equally.

5. The improved power supply system to provide trunk line power to a segment of a communications network according to claim 4 wherein each power supply device being loaded at a level far below the maximum operating amperage of each of the power supply devices.

6. The improved power supply system to provide trunk line power to one of a network and a segment of a network according to claim 1 further comprising:
communication for providing a status of one of a power supply and a network, the status indicating one of current, voltage output, and a problem with one of a power supply and detectable network problem.

7. The improved power supply system to provide trunk line power to a segment of a communications network according to claim 2 further comprising:
communication for providing status of one of a power supply and a network, including one of current, voltage output, and problems with one of a power supply and detectable network problem.

8. The improved power supply system according to claim 2 wherein the power supply devices being configured in a continuously load sharing configuration.

9. The improved power supply system comprising power supply devices to provide trunk line power to a segment of a network according to claim 1 wherein the multiplicity of power supply devices power LAN transceivers.

10. The improved power supply system to provide trunk line power according to claim 1 wherein the multiplicity of power supply devices having digital outputs, the improved power supply further comprising;
a digital output energizing a relay for interrupt of outgoing power through a network command.

11. The improved power supply system according to claim 10 further comprising:
a reset to the power to one of an entire and a segment of a network.

12. A method for using an improved power supply to provide trunk line power to one of a segment of a network and a network, the method comprising the following steps:
connecting a multiplicity of power supply devices to operate concurrently to provide power to a multiplicity of user devices.

13. The improved power supply system according to claim 1 further comprising:
the multiplicity of power supply devices being configured in a load sharing configuration.

14. The improved power supply system according to claim 1 further comprising:
current limiting circuit to limit current to the network.

15. The improved power supply system according to claim 1 further comprising:
a load sharing circuitry to load each of power supply devices equally.

16. The improved power supply system according to claim 15 wherein each power supply device being loaded at a level far below the maximum operating amperage of each of the power supply devices.

17. The improved power supply system according to claim 1 further comprising:
communication for providing a status of one of a power supply and a network, the status indicating one of current, voltage output, and a problem with one of a power supply and detectable network problem.
